(19) United States
(12) Patent Application Publication
(10) Pub. No.: US 2013/0248036 A1
(43) Pub. Date: Sep. 26, 2013

(54) Polygonal Fluid Flow Displacement Members

(71) Applicant: Feng Li, Shanghai (CN)

(72) Inventor: Feng Li, Shanghai (CN)

(73) Assignee: ACN Industry Co., Ltd, Shanghai (CN)

(21) Appl. No.: 13/057,011

(22) PCT Filed: Jan. 21, 2011
(86) PCT No.: PCT/CN11/70480

§ 371 Date: Feb. 1, 2011

(30) Foreign Application Priority Data
Dec. 17, 2010 (CN) 201010595486.X

(51) Int. Cl. F15D 1/06

(52) U.S. Cl. CPC F15D 1/06
USPC 138/39

(57) ABSTRACT

The present invention provides a fluid flow displacement member for linearizing the fluid inside a polygon conduit comprising in relation to the direction of fluid an upstream end and an optional downstream end, after the upstream end at least one peripheral edge. Also within the scope of this invention is a fluid flow apparatus containing such a fluid flow displacement member.

### BACKGROUND OF THE INVENTION

Non-linear or non-homogenous fluid is particularly undesirable in industry. It is generally disruptive and gives a difficult measurement of the velocity or volume of the flowing fluid. For virtually any flow condition the non-linearity of the velocity profile can be converted into a mean velocity of the fluid and an associated mean cross-sectional area. This however does not overcome the problem of non-linearity since changes in fluid flow conditions result in non-linear changes to the mean velocity and its associated cross-sectional area. As such, the non-linear characteristics of the fluid velocity profile have been accepted as an uncontrolled variable in flowmeter design with the knowledge that such non-linearity would necessarily detract from the range of flow rate condition over which the flowmeter could operate within acceptable error limits. Another problem associated with non-linearity is vortexmeter. See, e.g., U.S. Pat. No. 4,638,672; U.S. Pat. No. 5,814,738.

Currently, fluid flow displacement members known to the inventor are for liquids flowing in a round conduit. They are generally in a shape with at least a circular end, such as a cone device that is attached to the interior of the conduit and useful for reshaping the velocity profile of the flowing fluid. Such devices are capable of reducing the non-linearity of the flowing fluid. They are generally used for fluid in a circular conduit, e.g., oil in a metal round pipe. For non-linear fluid flowing in a polygon conduit, such devices are not effective and the inventor is not aware of any solutions for this shortcoming.

### SUMMARY OF THE INVENTION

In one aspect, the present invention provides a fluid flow apparatus which comprises a polygon conduit and a fluid flow displacement member in the polygon conduit.

The polygon conduit is defined by the interior surface of a peripheral wall for conveying fluid therethrough in a given direction and, relative to the direction, has an upstream end and a downstream end.

The fluid flow displacement member inside the polygon conduit has in relation to the direction of fluid an upstream end and an optional downstream end, and after the upstream end at least one peripheral edge being the bigger part of the displacement member and having essentially the same shape and the same number of sides as the section of the polygon conduit where this peripheral edge is located; wherein the upstream end is a single sharp point or of essentially the same shape as but smaller than the peripheral edge, the displacement member has between the upstream end and the peripheral edge at least one sloped wall forming an increasing periphery on the displacement member for deflecting the fluid to flow through a region defined between the peripheral edge of the displacement member and the polygon conduit, wherein the peripheral edge of the displacement member is normally positioned in a plane perpendicular to the direction of the fluid flow and each side of the peripheral edge being positioned in parallel to its corresponding side of the section of the polygon conduit where the peripheral edge is located, wherein the upstream end is normally located along the longitudinal central axis of the polygon conduit, so the displacement member is normally positioned coaxially in the polygon conduit.

By empirical studies, the inventor observed that the peripheral edge and periphery wall is effective to substantially linearize the fluid in at least the region over a predetermined range of flows through the polygon conduit. The displacement member can also have a downstream end being a single sharp point or of essentially the same shape as but smaller than the peripheral edge, and have between the peripheral edge and the optional downstream end at least one optional sloped wall forming a decreasing periphery on the displacement member. The fluid flow displacement member and the polygon conduit have at the upstream end or the downstream end thereof a device for mounting the displacement member coaxially in the polygon conduit, and the mounting device can be either fixed (thus not removable) or replaceable or removable (e.g., by insertion and wafer style, etc.).

In some embodiments, the displacement member is mounted to the polygon conduit by such a device as a supporting arm extending from the upstream end and inserted through and secured onto the wall of the fluid conduit, e.g., by bolts or flange. Such a mounting device would eliminate the conduit of the fluid flow apparatus and save material and cost of manufacture.

In some embodiments, the fluid flow displacement member is coaxially mounted in essentially the center of the polygon conduit.

In some other embodiments, the polygon conduit is of essentially uniform shape in the section where it overlaps with the fluid flow displacement member.

In still some other embodiments, the fluid flow displacement member has only one peripheral edge.

The ratio of the plane area surrounded by the largest peripheral edge of the fluid flow displacement member to the area of the section of the polygon conduit where this peripheral edge locates can be in the range of from about 0.05 to about 0.95 (e.g., from about 0.30 to about 0.80, from about 0.50 to about 0.80, from about 0.70 to about 0.80, from about 0.30 to about 0.60, or about 0.45).

In some further embodiments, the polygon conduit and the fluid flow displacement member are both made of metal (e.g., carbon steel, stainless steel, iron, aluminum, or an alloy thereof).

In still some further embodiments, the fluid flow apparatus further includes one or more flowmeters mounted to or connected with the polygon conduit, wherein each of the flowmeters is capable of measuring the velocity, flow rate, pressure, or mass of the fluid flowing through the polygon conduit.

In some further embodiments, the fluid flowing through the polygon conduit is in the liquid or gaseous state. For instance, the gaseous fluid flowing through the polygon conduit can include air, stack gases, coke-oven gas, bio-gas, pulverized-fuel gas, an inert gas (e.g., argon) or water steam. Examples of liquid fluids include water and oil.

In yet some further embodiments, the polygon conduit is part of a rectangular, square, pentagonal, or triangular pipe, e.g., a rectangular or square pipe. The size of the polygon conduit can be about, e.g., 6.0 m×6.0 m (i.e., meter), 4 m×1.6 m, 3.0 m ×1.2 m, or 0.4 m×0.8 m.

In another aspect, the invention provides a fluid flow displacement member for linearizing the fluid flowing in a polygon conduit. Specifically, the fluid flow displacement member includes, in relation to the direction of the flow, an upstream end and at least one peripheral edge, wherein the peripheral edge has essentially the same shape and the same number of sides as the section of the polygon conduit where this peripheral edge is located, the upstream end is either a single sharp point or of essentially the same shape as but even smaller than the peripheral edge. The peripheral edge of the displacement member is of same shape but smaller size than the section of the polygon conduit where the peripheral edge locates and has between the ends thereof sloped wall forming a periphery on the displacement member for deflecting the fluid to flow through a region defined between the peripheral edge of the displacement member and the polygon conduit, the peripheral edge and periphery wall being effective to substantially linearize the velocity profile, flow rate or vortex shedding of the fluid in at least the region over a predetermined range of flows through the polygon conduit, and the fluid flow displacement member is placed inside the polygon conduit and is attached thereto.

In some embodiments, the upstream end is a single sharp point.

In some other embodiments, the upstream end is of essentially the same shape as but smaller than the peripheral edge. For instance, the upstream end can be about 0.1-50% or 5-25% of the size of the peripheral edge.

In yet some further embodiments, the plane area surrounded by the peripheral edge is about 5-95% of the area of the section of the polygon conduit where the peripheral edge is located (e.g., about 30-80%, about 50-80%, about 70-80%, about 30-60%, or about 45%).

In some further other embodiments, the peripheral edge is of the rectangular, square, pentagonal, or triangular shape (e.g., the rectangular or square shape).

The advantages offered by the fluid flow apparatus of this invention include, but are not limited to, effectively mixing the flowing fluid, create optimal vortex condition for measurement and increasing the linear rangeability of the flowmeter, (e.g., greater linearity between the pressure differential and the square of the fluid flow rate).

As used herein, the term ‘or’ has the meaning of both ‘and’ and ‘or.’

As used herein, the term ‘peripheral edge’ refers to the outer contour of a distinctive bigger end of the displacement member with a sloped wall extending toward an upstream end. In general, the longer upstream extension of the periphery wall of the displacement member, the greater linearity of the flow velocity can be achieved, however the smaller pressure differential across the displacement member can be created, which can be difficult for a flowmeter to measure. To achieve both the optimal linearity of flow condition and the required pressure differential, by empirical studies, the displacement member may have more than one peripheral edge if it has increasing peripheries of different slopes formed by periphery wall. For instance, if a displacement member has two (or more) adjacent increasing or enlarging peripheries of different slopes, the first section having a slope of 60° (degree) to the longitudinal central axis of the polygon conduit and the second section starting at the end of the first section with a slope of 25° (degree) to the longitudinal central axis of the polygon conduit, then the displacement member has two peripheral edges, one at the end of the first section of the periphery (with a 60° slope) and the other at the end of the second periphery (with a 25° slope). Also by empirical studies, in line with the direction of the flow, after the biggest peripheral edge there can also be decreasing peripheral wall (i.e., with a negative slope) extended toward the optional downstream end of the displacement member which is a single sharp point or essentially the same and smaller shape of the peripheral edge. The decreasing peripheral wall can reduce pressure loss in the fluid across the displacement member, optimize return velocity and create optimal vortex condition and fluid mixing effects. The extension of the periphery wall from the largest peripheral edge to an optional downstream end is often smaller than that from the largest peripheral edge to an upstream end.

As used herein, the term ‘linearize’ means to change at least an aspect of the profile of a fluid, e.g., velocity, flow rate, or vortex shedding, which is originally uneven or nonlinear, and make it substantially linear or substantially increase the linear rangeability.

As used herein, the term ‘displacement’ means that the direction of the flow of the fluid is adjusted or changed.

### BRIEF DESCRIPTIONS OF THE DRAWINGS

FIG. 1 is a cross-sectional view of a fluid flow apparatus of this invention that includes, in relation to the flow direction, a first opening (P1) on the fluid conduit before the upstream end of the displacement member for connecting to one or more flowmeters and a second opening (P2) on the fluid conduit after the peripheral edge of the displacement member also for connecting to the same or more flowmeters. The fluid displacement member is mounted to the fluid conduit by the so-called wafer design, i.e. the downstream end of the displacement member is mounted by supporting elements being tightened in between the pipe flanges.

FIG. 2 is a sectional view from the upstream of the same fluid flow apparatus of this invention depicted in FIG. 1, wherein the peripheral edge is of the same shape and has the same number of sides as does the section of the polygon conduit where this peripheral edge locates, each side of the peripheral edge being parallel to the corresponding side of the section of the polygon conduit, and the upstream end of the displacement member is positioned at a place along the longitudinal central axis of the polygon conduit, so that the displacement member is positioned coaxially in the polygon conduit. This apparatus includes a rectangular conduit, a rectangular (shape of the peripheral edge) fluid displacement member, in relation to the flow direction, an outlet (P1) on the fluid conduit before the upstream end of the fluid displacement member, and an outlet (P2) on the fluid conduit after the peripheral edge of the fluid displacement member.

FIG. 3 is a cross-sectional view of a fluid flow apparatus of this invention, that includes, in relation to the flow direction, a first opening (P1) on the fluid conduit before the upstream end, and a second opening (P2) on the fluid conduit after the largest peripheral edge, wherein the second opening being the outlet of a flowpath consisted of a hollow supporting arm connected with the upstream end of the displacement member which is also hollow inside and has an aperture on the downstream end. Both openings are for connection to one or more flowmeters to measure at least one state of the liquid flow. In the fluid flow apparatus, both the upstream end and the downstream end of the fluid displacement member are secured to the polygon conduit, and the fluid displacement member has 2 peripheral edges.

### DETAILED DESCRIPTION OF THE INVENTION

The present invention generally provides solutions for linearizing non-linear fluid that flows in a polygon conduit.

In one aspect, the present invention provides a fluid flow apparatus which includes a polygon conduit and a fluid flow displacement member in the polygon conduit.

The polygon conduit is defined by the interior surface of a peripheral wall for conveying fluid therethrough in a given direction and, relative to the direction, has an upstream end and a downstream end.

The fluid flow displacement member inside the polygon conduit has in relation to the direction of fluid an upstream end and an optional downstream end, and after the upstream end at least one peripheral edge being the bigger part of the displacement member and having essentially the same shape and the same number of sides as the section of the polygon conduit where this peripheral edge is located; wherein the upstream end is a single sharp point or of essentially the same shape as but smaller than the peripheral edge, the displacement member has between the upstream end and the peripheral edge at least one sloped wall forming an increasing periphery on the displacement member for deflecting the fluid to flow through a region defined between the peripheral edge of the displacement member and the polygon conduit, wherein the peripheral edge of the displacement member is normally positioned in a plane perpendicular to the direction of the fluid flow and each side of the peripheral edge being positioned in parallel to its corresponding side of the section of the fluid conduit where the peripheral edge is located, wherein the upstream end is normally located along the longitudinal central axis of the polygonal conduit, so the displacement member is normally positioned coaxially in the polygonal conduit.

By empirical studies, the inventor observed that the peripheral edge and periphery wall is effective to substantially linearize the fluid in at least the region over a predetermined range of flows through the polygon conduit, the displacement member can also has a downstream end being a single sharp point or of essentially the same shape as but smaller than the peripheral edge and has between the peripheral edge and the optional downstream end at least one optional sloped wall forming a decreasing periphery on the displacement member. The fluid flow displacement member and the polygon conduit have at the upstream end or the optional downstream end thereof a device for mounting the displacement member coaxially in the polygon conduit, and the mounting device can be either fixed (thus not removable) or replaceable or removable (e.g., by insertion and wafer style, etc.).

In one aspect, the invention is a fluid flow apparatus which comprises a polygon conduit and a fluid flow displacement member in the polygon conduit. In this apparatus, the polygon conduit is defined by the interior surface of a peripheral wall for conveying fluid therethrough in a given direction and, relative to the direction, it has an upstream end and a downstream end; the fluid flow displacement member inside the polygon conduit has in relation to the direction of fluid an upstream end and after the upstream end at least one peripheral edge being the bigger part of the displacement member and having essentially the same shape and the same number of sides as the section of the polygon conduit where this peripheral edge is located; wherein the upstream end is a single sharp point or of essentially the same shape as but smaller than the peripheral edge, the displacement member has between the upstream end and the peripheral edge at least one sloped wall forming an increasing periphery on the displacement member for deflecting the fluid to flow through a region defined between the peripheral edge of the displacement member and the polygon conduit, wherein the peripheral edge of the displacement member is normally positioned in a plane perpendicular to the direction of the fluid flow and each side of the peripheral edge being positioned in parallel to its corresponding side of the section of the polygon conduit where the peripheral edge is located, wherein the upstream end is normally located at a place along the longitudinal central axis of the polygon conduit, so the displacement member is normally positioned coaxially in the polygon conduit. By empirical studies, the inventor observed that the peripheral edge and periphery wall is effective to substantially linearize the fluid in at least the region over a predetermined range of flows through the polygon conduit, the displacement member can also have a downstream end being a single sharp point or of essentially the same shape as but smaller than the peripheral edge and has between the peripheral edge and the downstream end at least one sloped wall forming a decreasing periphery on the displacement member; and the fluid flow displacement member and the polygon conduit have at the upstream end or at the downstream end thereof a device for mounting the displacement member in the polygon conduit, which is optionally detachable or removable.

Two key features of this apparatus include (1) the peripheral edge of the displacement member being in substantially the same shape as but smaller than the section of the polygon conduit where the peripheral edge is located; and (2) the periphery wall of the displacement members is so sloped that it deflects or replaces the flowing fluid and makes it go through the region defined between the peripheral edge and the polygon conduit. By empirical studies, this peripheral edge and periphery wall is effective to substantially linearize the fluid in at least the region over a predetermined range of flows through the polygon conduit. At the same time, the displaced fluid mixes to give a substantially uniform property of the fluid. For instance, a flowing fluid may have been un-uniformly mixed from a number of component gases or mixed with floating solid particles inside the flow and has different compositions in different phases or partition of the flow. As a result of the displacement member and the mixing effect of the space between the peripheral edge and the polygon conduit, the flowing fluid may be homogenized to give substantial uniformity in its properties. As a result, the flowing fluid is more suitable for application, and its properties and the flowing volume can be measured with significantly enhanced accuracy. Additionally, this may result in lower pressure loss and energy saving in delivering the flowing fluid through a polygon conduit while achieving the same throttling effects.

One specific example of flowing fluid that may require such mixture or uniformity is the powdered-coal and other pulverized fuel gas used, e.g., in an industrial oven and delivered in a rectangular pipe or conduit.

The fluid flow apparatus containing this type of displacement member may also be particularly useful or even ideal for dirty and dusty gases, e.g., stack gases and biogases, which are prone to clog or foul the throttling devices inside the flow, empirical studies reveal that the sloped periphery wall of the displacement member substantially decreased clogging possibilities and achieves self-cleansing effect while deflecting or displacing the flowing fluid.

The displacement member can be secured to the polygon conduit, e.g., by using two or more legs that connect the upstream end or the optional downstream end or the both ends of the displacement member and the polygon conduit. Preferably, the displacement member is symmetrically or centrally placed in the polygon conduit to achieve optimal linearizing and mixing effects of the flowing fluid.

The polygon conduit can optionally include a smaller interior polygon conduit which can help keeping the temperature of the flowing fluid. The displacement member can be attached to this interior polygon conduit.

The fluid flow apparatus can be optionally connected to one or more flowmeters through one or more openings on its fluid conduit so that the different profiles of the fluid can be measured.

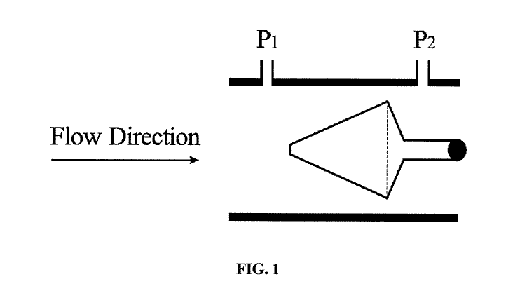

FIG. 1 is a cross-sectional view of such an apparatus that includes, in relation to the flow direction, a first opening (P1) on the fluid conduit before the upstream end of the displacement member for connecting to one or more flowmeters and a second opening (P2) on the fluid conduit after the peripheral edge of the displacement member also for connecting to the same or more flowmeters. The displacement member is secured at its downstream end through means derived from the center point of its downstream end.

Another aspect of this invention relates to a fluid flow displacement member for linearizing the fluid flowing in a polygon conduit. Two key features of this member are the same as those in the fluid flow apparatus discussed above—i.e., the substantially same shape between its peripheral edge and section of the polygon conduit in which the peripheral edge is located; and the sloped periphery walls that deflects or displaces the flowing fluid.

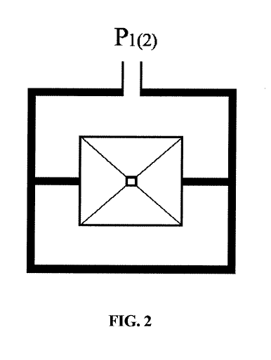

FIG. 2 is a sectional view from the upstream of the same fluid flow displacement member as depicted in FIG. 1 that is placed in the center of a rectangular conduit. The arrangement is such that the peripheral edge is of the same shape and has the same number of sides as does the section of the polygon conduit where this peripheral edge locates, each side of the peripheral edge being parallel to the corresponding side of the section of the polygon conduit, and the upstream end of the displacement member is positioned at a place along the longitudinal central axis of the polygon conduit, so that the displacement member is positioned coaxially in the polygon conduit. This feature enables the linearizing and mixing of the flowing fluid such that a certain profile (e.g., velocity, flow rate, vortex shedding, or composition of fluid) is substantially linearized or homogenized.

The fluid flow displacement member of this invention, or the fluid flow displacement member in the fluid flow apparatus of this invention, may include at least two peripheral edges and the upstream end is of essentially the same shape as but smaller than either peripheral edge.

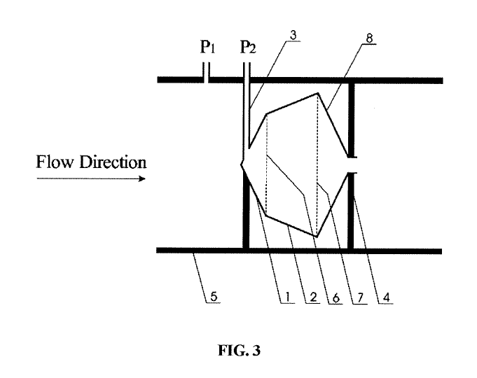

FIG. 3 depicts an example with an upstream end being a single sharp point. In this example, the fluid flow displacement member is secured to the polygon conduit 5 by bars connected to its both ends. One of the bars, 3, which is hollow inside, is through the upstream up and secured at the wall of the polygon conduit at the opening P2, that P2 being the outlet of a flowpath consisted of the hollow bar 3 connected with the upstream end of the displacement member which is also hollow inside and has an aperture on the downstream end; the other bar 4 is connected to the downstream end of the displacement member and is also secured to the wall of the polygon conduit. There are two peripheral edges in the displacement member. The first peripheral edge 6 is at the end of periphery wall 1, and the second peripheral edge 7 is at the end of periphery wall 2. Periphery wall 1 has a steeper slope than periphery wall 2, whereas periphery wall 8 after the second peripheral edge 7 has a negative slope.

When a polygonal displacement member with a peripheral edge of essentially the same shape and same number of sides as the section of the polygon conduit inside which this displacement member is located, but smaller in area than the section of the polygon conduit, the space between the displacement member and the polygon conduit changes along the displacement member, with the space between the peripheral edge and the polygon conduit being smaller or the smallest. The inventor unexpectedly discovered that this change (decrease) of space forces the fluid to deflect in direction and flow across the displacement member, effectively creating a greater linearity of velocity profile of the flowing fluid in at least the region defined between the peripheral edge and the polygon conduit over a predetermined range of flows through the polygon conduit.

Extension of periphery wall from the peripheral edge of the polygonal displacement member toward an upstream end which is a single sharp point or essentially the same shape but smaller than the peripheral edge, forms a polygonal frustum, with the peripheral edge being the bigger part of this polygonal frustum. The polygonal frustum and the polygon conduit means reshapes the fluid velocity profile and can achieve an even greater linearity of the fluid velocity, and at the same time generates ideal vortex condition and mixing effects of the fluid composition, which can be ideal for flow measurement. For instance, a flowmeter can measure the pressure differential across the displacement member to calculate flow rate, volume or mass of flow, etc. Optionally, the periphery wall can have different slope sections to achieve an optimal result between the maximal linearity of the velocity profile and the desirable pressure differential across the displacement member for flow measurement.

Further optionally, extension of wall from the peripheral edge toward a downstream end to create an ideal vortex condition, help the return velocity of the fluid as it resumes the free flow condition in the fluid conduit, and is beneficial to the mixing effect of fluid composition.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. All publications referenced herein are incorporated by reference in their entireties.

1. Fluid flow apparatus comprising:
a polygon conduit being defined by the interior surface of a peripheral wall for conveying fluid therethrough in a given direction, the conduit having relative to the direction an upstream end and a downstream end; and
a fluid flow displacement member inside the polygon conduit comprising in relation to the direction of fluid an upstream end, after the upstream end at least one peripheral edge being a bigger part of the displacement member than the upstream end and having essentially the same shape and the same number of sides as the section of the polygon conduit where this peripheral edge is located; wherein the upstream end is a single sharp point or of essentially the same shape as but smaller than the peripheral edge, the displacement member has between the upstream end and the peripheral edge at least one sloped wall forming an increasing periphery on the displacement member for deflecting the fluid to flow through a region defined between the peripheral edge of the displacement member and the polygon conduit, the peripheral edge and the sloped wall being effective to substantially linearize the fluid in at least the region over a predetermined range of flows through the polygon conduit, the displacement member has an optional downstream end which is a single sharp point or of essentially the same shape as but smaller than the peripheral edge and has between the peripheral edge and the optional downstream end at least one sloped wall forming a decreasing periphery on the displacement member;
the peripheral edge of the displacement member is normally positioned in a plane perpendicular to the direction of the fluid flow and each side of the peripheral edge being positioned in parallel to its corresponding side of the section of the polygon conduit where the peripheral edge is located, wherein the upstream end is normally located at a place along the longitudinal central axis of the polygon conduit, so the displacement member is normally positioned coaxially in the polygon conduit; and
the fluid flow displacement member and the polygon conduit having at the upstream or downstream end thereof device for mounting the displacement member coaxially in essentially the center of the polygon conduit.

2. The fluid flow apparatus of claim 1, wherein the upstream end is a single sharp point.

3. The fluid flow apparatus of claim 1, wherein the polygon conduit is of essentially uniform shape in the section where it overlaps with the fluid flow displacement member.

4. The fluid flow apparatus of claim 3, wherein the fluid flow displacement member comprises only one peripheral edge and the upstream end is of essentially the same shape as but smaller than the peripheral edge.

5. The fluid flow apparatus of claim 4, wherein the ratio of the plane area surrounded by the peripheral edge to the area of the section of the polygon conduit where the peripheral edge locates is in the range of about 0.05 to about 0.95.

6. The fluid flow apparatus of claim 5, wherein the ratio of the plane area surrounded by the peripheral edge to the area of the section of the polygon conduit where the peripheral edge locates is in the range of about 0.30 to about 0.80.

7. The fluid flow apparatus of claim 6, wherein the ratio of the plane area surrounded by the peripheral edge to the area of the section of the polygon conduit where the peripheral edge locates is in the range of about 0.50 to about 0.80.

8. The fluid flow apparatus of claim 7, wherein the ratio of the plane area surrounded by the peripheral edge to the area of the section of the polygon conduit where the peripheral edge locates is in the range of about 0.70 to about 0.80.

9. The fluid flow apparatus of claim 6, wherein the ratio of the plane area surrounded by the peripheral edge to the area of the section of the polygon conduit where the peripheral edge locates is in the range of about 0.30 to about 0.60.

10. The fluid flow apparatus of claim 6, wherein the ratio of the plane area surrounded by the peripheral edge to the area of the section of the polygon conduit where the peripheral edge locates is about 0.45.

11. The fluid flow apparatus of claim 1, wherein the polygon conduit and the fluid flow displacement member are both made of metal.

12. The fluid flow apparatus of claim 11, wherein the polygon conduit and the fluid flow displacement member are both made of steel, iron, aluminum, or an alloy thereof.

13. The fluid flow apparatus of claim 1, wherein the device for mounting the displacement member inside the polygon conduit is replaceable or removable.

14. The fluid flow apparatus of claim 1, furthering comprising one or more additional flowmeters connected to the polygon conduit wherein the additional flowmeters are capable of measuring the velocity, pressure, or volume of the fluid flowing through the polygon conduit.

15. The fluid flow apparatus of claim 1, wherein the fluid flowing through the polygon conduit is in the gaseous state.

16. The fluid flow apparatus of claim 1, wherein the fluid flowing through the polygon conduit comprises air, stack gases, coke-oven gas, bio-gas, pulverized-fuel gas, or an inert gas.

17. The fluid flow apparatus of claim 16, wherein the air comprises oxygen, nitrogen, or water steam.

18. The fluid flow apparatus of claim 1, wherein the polygon conduit is a rectangular, square, pentagonal, or triangular conduit.

19. The fluid flow apparatus of claim 18, wherein the polygon conduit is a rectangular or square conduit.

20. The fluid flow apparatus of claim 1, wherein the fluid flow displacement member comprises at least two peripheral edges.

21. A fluid flow displacement member for linearizing the fluid inside a polygon conduit comprising in relation to the direction of fluid an upstream end and after the upstream end at least one peripheral edge being bigger than the upstream end of the displacement member and having essentially the same shape and the same number of sides as the section of the polygon conduit where this peripheral edge is located; wherein the upstream end is a single sharp point or of essentially the same shape as but smaller than the peripheral edge, the displacement member has between the upstream end and the peripheral edge at least one sloped wall forming an increasing periphery on the displacement member for deflecting the fluid to flow through a region defined between the peripheral edge of the displacement member and the polygon conduit, the wall being effective to substantially linearize the fluid in at least the region over a predetermined range of flows through the polygon conduit, the displacement member has an optional downstream end being a single sharp point or of essentially the same shape as but smaller than the peripheral edge and has between the peripheral edge and the downstream end at least one sloped wall forming a decreasing periphery on the displacement member.

22. The fluid flow displacement member of claim 21, wherein the upstream end is a single sharp point.

23. The fluid flow displacement member of claim 21, wherein the fluid flow displacement member comprises only one peripheral edge and the upstream end is of essentially the same shape as but smaller than the peripheral edge.

24. The fluid flow displacement member of claim 23, wherein the upstream end is about 0.1-50% of the size of the peripheral edge.

25. The fluid flow displacement member of claim 24, wherein the upstream end is about 5-25% of the size of the peripheral edge.

26. The fluid flow displacement member of claim 23, wherein the plane area surrounded by the peripheral edge is about 5-95% of the area of the section of the polygon conduit where the peripheral edge locates.

27. The fluid flow displacement member of claim 26, wherein the plane area surrounded by the peripheral edge is about 30-80% of the area of the section of the polygon conduit where the peripheral edge locates.

28. The fluid flow displacement member of claim 27, wherein the plane area surrounded by the peripheral edge is about 50-80% of the area of the section of the polygon conduit where the peripheral edge locates.

29. The fluid flow displacement member of claim 28, wherein the plane area surrounded by the peripheral edge is about 70-80% of the area of the section of the polygon conduit where the peripheral edge locates.

30. The fluid flow displacement member of claim 26, wherein the plane area surrounded by the peripheral edge is about 30-60% of the area of the section of the polygon conduit where the peripheral edge locates.

31. The fluid flow displacement member of claim 30, wherein the plane area surrounded by the peripheral edge is about 45% of the area of the section of the polygon conduit where the peripheral edge locates.

32. The fluid flow displacement member of claim 21, wherein the peripheral edge is of the rectangular, square, pentagonal, or triangular shape.

33. The fluid flow displacement member of claim 32, wherein the peripheral edge is of the rectangular or square shape.

34. The fluid flow displacement member of claim 21, wherein the fluid flow displacement member comprises at least two peripheral edges.
